(19) United States
(12) Patent Application Publication
(10) Pub. No.: US 2007/0256709 A1
(43) Pub. Date: Nov. 8, 2007

(54) METHODS AND APPARATUS FOR OPERATING AN INKJET PRINTING SYSTEM

(76) Inventors: QUANYUAN SHANG, Saratoga, CA (US); Shinichi Kurita, San Jose, CA (US); Lizhong Sun, San Jose, CA (US)

Correspondence Address: DUGAN & DUGAN, PC, 55 SOUTH BROADWAY, TARRYTOWN, NY, 10591, US

(21) Appl. No.: 11/741,722

(22) Filed: Apr. 28, 2007

Related U.S. Application Data
(60) Provisional application No. 60/795,709, filed on Apr. 29, 2006.
(60) Provisional application No. 60/796,297, filed on Apr. 29, 2006.

(51) Int. Cl. B08B 7/04; B08B 13/00; B08B 3/08; B08B 7/00

(52) U.S. Cl. 134/18; 134/198; 134/201; 134/42; 29/592

(57) ABSTRACT

The invention provides a method of operating a inkjet printing system that may include a print head parking structure and a print head cleaning station. A print head parking structure may include a solvent and/or nozzle surface treatment bath for inkjet print heads. Print heads may be returned to the print head parking structure after a substrate has been printed, after one or more printing passes, and/or frequently enough to prevent ink from drying on or clogging the print heads. Once sealed within the print head parking structure, the print heads (or a portion thereof) may be dipped in a solvent bath to dissolve or wash away any ink that has been deposited on the print heads. The print heads may be coated with a surface treatment that improves jetting reliability. The print heads may be dried and moved to the print head cleaning station where they may be wiped and pre-jetting may be performed.

The present application claims priority to U.S. patent application Ser. No. 11/493,310, filed Jul. 26, 2006 and entitled “METHODS AND APPARATUS FOR MAINTAINING INKJET PRINT HEADS USING PARKING STRUCTURES WITH SPRAY MECHANISMS”, (Attorney Docket No. 11334, now 10648), U.S. Provisional Patent Application Ser. No. 60/795,709, filed Apr. 29, 2006 and entitled “METHODS AND APPARATUS FOR MAINTAINING INKJET PRINT HEADS USING PARKING STRUCTURES”, (Attorney Docket No. 10648/L) and U.S. Provisional Patent Application Ser. No. 60/796,297, filed Apr. 29, 2006 and entitled “METHODS AND APPARATUS FOR OPERATING AN INKJET PRINTING SYSTEM”, (Attorney Docket No. 10647/L) which are hereby incorporated herein by reference in their entirety for all purposes.

### CROSS-REFERENCE TO RELATED APPLICATIONS

The present application is related to:

U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING” (Attorney Docket No. 9521/L);

U.S. patent application Ser. No. 11/019,930, filed Dec. 22, 2004 and titled “METHODS AND APPARATUS FOR ALIGNING PRINT HEADS” (Attorney Docket No. 9521-3/DISPLAY/AKT/RKK);

U.S. patent application Ser. No. 11/123,502, filed May 4, 2005 and titled “DROPLET VISUALIZATION OF INKJETTING” (Attorney Docket No. 9705)

U.S. patent application Ser. No. 11/238,631 filed Sep. 29, 2005 and entitled “METHODS AND APPARATUS FOR INKJET PRINT HEAD CLEANING” (Attorney Docket No. 9838);

U.S. Provisional Patent Application Ser. No. 60/721,340 filed Sep. 27, 2005 and entitled “INKJET DELIVERY MODULE” (Attorney Docket No. 10145/L); and

U.S. patent application Ser. No. 11/493,297 filed Jul. 26, 2006 and entitled “METHODS AND APPARATUS FOR INKJET PRINTING SYSTEM MAINTENANCE” (Attorney Docket No. 9521-11), which are each hereby incorporated herein by reference in its entirety for all purposes.

### FIELD OF THE INVENTION

The present invention relates generally to inkjet printing systems employed during flat panel display formation, and is more particularly concerned with apparatus and methods for maintaining inkjet print heads.

### BACKGROUND OF THE INVENTION

The flat panel display industry has been attempting to employ inkjet printing to manufacture display devices, in particular, color filters. However, inkjet print heads used in inkjet printing may become filled with ink, clogged, coated, or otherwise rendered unsuitable for use in an inkjet printing process. Conventional methods for cleaning inkjet print heads involve a manual wiping process. This process often includes bringing inkjet print heads offline and away from a clean production environment, is slow and may damage or shift a print head from a desired print position. Accordingly, improved methods and apparatus for maintaining an inkjet print head are desired.

### SUMMARY OF THE INVENTION

The invention provides a method of operating a inkjet printing system that may include a print head parking structure and a print head cleaning station. A print head parking structure may include a solvent and/or nozzle surface treatment bath for inkjet print heads. Print heads may be returned to the print head parking structure after a substrate has been printed, after one or more printing passes, and/or frequently enough to prevent ink from drying on or clogging the print heads. Once sealed within the print head parking structure, the print heads (or a portion thereof) may be dipped in a solvent bath to dissolve or wash away any ink that has been deposited on the print heads. The print heads may be coated with a surface treatment that improves jetting reliability. The print heads may be dried and moved to the print head cleaning station where they may be wiped and pre-jetting may be performed.

In aspects of the invention, a method of operating an inkjet printing system for manufacturing color filters for flat panel displays includes processing a print head in a parking structure, processing the print head in a cleaning station, pre-jetting the print head in the cleaning station, and printing a color filter.

In some embodiments of the invention, a print head parking structure is employed to apply a surface treatment solution to the nozzle surfaces of a print head. A mixture of alkyl thiol and ionic alkyl thiol may be dissolved in a solvent to create the surface treatment solution.

Other features and aspects of the present invention will become more fully apparent from the following detailed description, the appended claims and the accompanying drawings.

### BRIEF DESCRIPTION OF THE DRAWINGS

FIG. 1 is a front perspective schematic view of an inkjet printing system according to some aspects of the present invention;

FIG. 2 is a close-up perspective view of a print head located above an example embodiment of a print head parking structure according to some aspects of the present invention;

FIG. 3 is a front plan schematic view of a print head parked in an example parking structure according to some aspects of the present invention;

FIG. 4A is a cross-sectional front plan schematic view of a print head parked in an example parking structure according to some aspects of the present invention;

FIG. 4B is a cross-sectional side plan schematic view of a print head parked in an example parking structure according to some aspects of the present invention;

FIG. 5 is a flowchart depicting an example process of employing a parking structure according to some aspects of the present invention;

FIG. 6 is a flowchart depicting an example process of using an inkjet printing system according to some aspects of the present invention; and

FIG. 7 is a schematic perspective view of a system for inkjet printing system maintenance according to some aspects of the present invention.

### DETAILED DESCRIPTION

The nozzles of inkjet printer heads used in the manufacture of color filters for flat panel displays may become clogged or otherwise obstructed by ink drying on or in the print heads. While various methods of cleaning and purging the nozzles may be employed to remove dried ink, methods that may eliminate or reduce the amount of ink that dries on the print heads may use a print head parking structure that includes a solvent and/or surface treatment bath for the print heads.

In operation, the print heads may be returned to the print head parking structure after a substrate has been printed, after one or more printing passes, and/or frequently enough to prevent ink from drying on or clogging the print heads. Once within the print head parking structure, the print heads (or a portion thereof) may be dipped in a solvent bath or pool to dissolve or wash away any ink that has been deposited on the print heads.

In some embodiments, high frequency vibrational energy (e.g., mega and/or ultrasonic energy) and/or heat may be applied to the solvent bath when the print heads are present to further help remove or dissolve any ink that has been deposited on the print heads. The solvent bath may include a valve system adapted to flush away and drain any used solvent with dissolved ink and refill the bath with clean solvent. The print heads themselves may be caused to jet solvent into the bath to purge any ink within the nozzles. In additional or alternative embodiments, the solvent bath may include spray nozzles adapted to spray the print heads with solvent instead of, or in addition to, dipping them in the bath. Alternatively or additionally, the print head parking structure may include other nozzles for applying, e.g., clean dry air (CDA) to the print heads to remove any excess solvent from the print heads before the heads are again used for printing.

In some embodiments, the print head parking structure may be used to apply a surface treatment to the print heads and/or the nozzles of the print heads. The print heads and/or nozzles may be submerged, sprayed, or otherwise coated with a chemical or treatment selected to make the surfaces of the print heads and/or nozzles inkphobic which causes ink to tend not to wet (e.g., bead on) the surfaces.

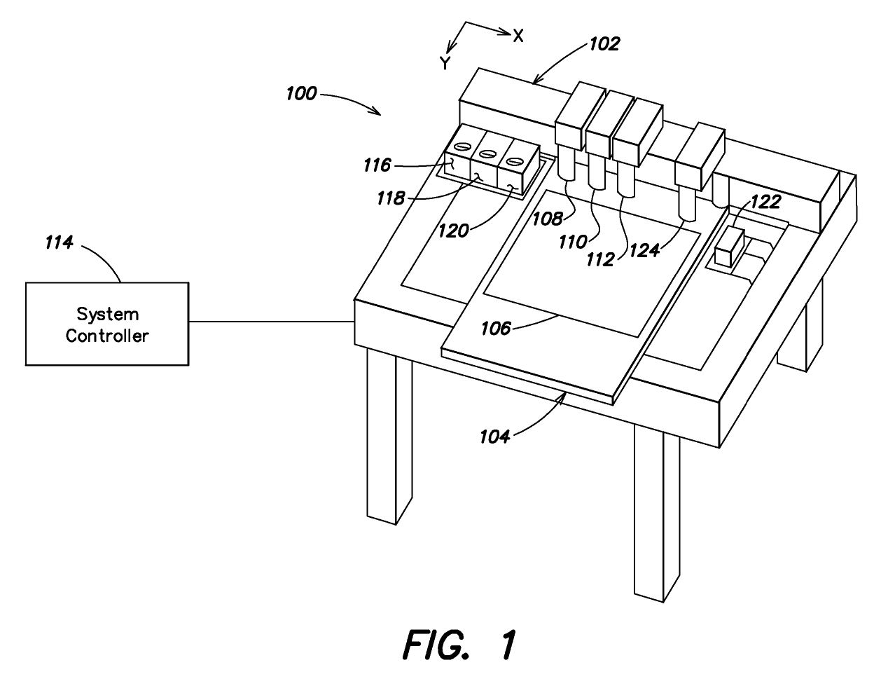

FIG. 1 illustrates a front perspective view of an embodiment of an inkjet printing system of the present invention which is designated generally by reference numeral 100. The inkjet printing system 100 of the present invention, in an exemplary embodiment, may include a print bridge 102. The print bridge 102 may be positioned above and/or coupled to a stage 104. The stage 104 may support a substrate 106. Supported on print bridge 102 may be print heads 108, 110, 112. Print heads 108, 110, 112 and print bridge 102 may be coupled (e.g., logically and/or electrically) to a system controller 114. The inkjet printing system 100 of the present invention may also include one or more print head parking stations 116, 118, 120 and one or more print head cleaning stations 122.

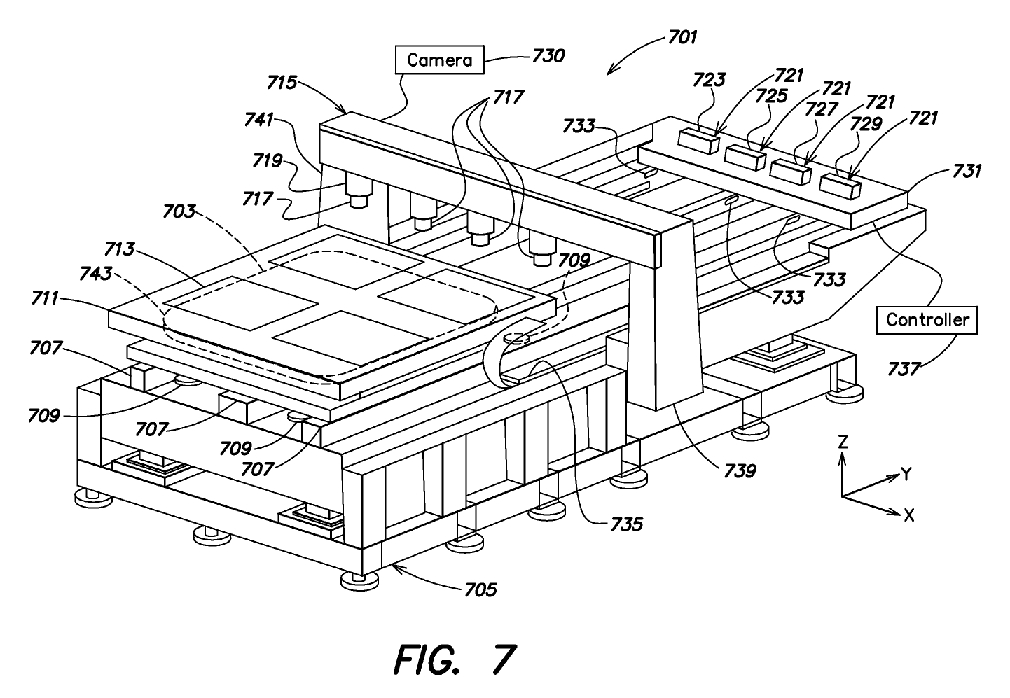

As described in previously incorporated U.S. application Ser. No. 11/493,297 and in further detail below with respect to FIG. 7, it may be undesirable to move the print heads between the various maintenance stations, such as from the print head parking station to the print head cleaning station, because such motion the print heads between stations may increase an overall display device processing time. Thus, in some embodiments, instead moving the print heads between the maintenance modules, the stations may move to accommodate the print heads. For example, the one or more maintenance stations may be mounted to one or more platforms. The platforms move to position the maintenance station under a print head requiring maintenance. In this embodiment, display device processing time is not used to move the print heads, thereby increasing the efficiency of the entire system.

In the exemplary embodiment of FIG. 1, the print bridge 102 may be supported above the stage 104 in such a manner as to facilitate inkjet printing. The print bridge 102 and/or stage 104 may be movable each independently in both the positive and negative X- and Y-directions as indicated by the X- and Y-direction arrows in FIG. 1. In the same or alternative embodiments print bridge 102 and stage 104 may be rotatable. The print bridge 102 may be capable of supporting and moving any number of print heads 108, 110, 112 and/or other devices (e.g., sensors, imaging system, range finder, etc.). The substrate 106 may sit atop or, in some embodiments, be coupled to the movable stage 104.

Although only three print heads 108, 110, 112 are shown on print bridge 102 in FIG. 1, it is important to note that any number of print heads may be mounted on and/or used in connection with the print bridge 102 (e.g., 1, 2, 4, 5, 6, 7, etc. print heads). Print heads 108, 110, 112 may each be capable of dispensing a single color of ink or, in some embodiments, may be capable of dispensing multiple colors of ink. Inkjet print heads 108, 110, 112 may be movable and/or alignable vertically, horizontally and/or rotationally so as to enable accurate inkjet drop placement. The print bridge 102 may also be movable and/or rotatable to position print heads 108-112 for accurate inkjet printing. In operation, the inkjet print heads 108, 110, 112 may dispense ink (e.g., from nozzles) in drops.

An example of a commercially available print head suitable for use with the present invention is the model SX-128, 128-Channel Jetting Assembly manufactured by Spectra, Inc. of Lebanon, N.H. This particular jetting assembly includes two electrically independent piezoelectric slices, each with sixty-four addressable channels, which are combined to provide a total of 128 jets. The print head includes a number of nozzles which are arranged in a single line, at approximately 0.020″ distance between nozzles. Other print heads with differently sized nozzles may also be used. In some embodiments, gold plated or gold coated print heads/nozzles may be used to help reduce wetting of the print heads/nozzles, particularly in conjunction with inkphobic surface treatments. Less wetting results in improved jetting performance by improving jetting reliability and drop size repeatability.

In some embodiments, an imaging system 124 capable of capturing images of the substrate 106, ink drops released from print heads 108, 110, 112, and/or nozzles of the print heads 108, 110, 112, may be included in the inkjet printing system 100. Such an imaging system 124 may be adapted to be capable of capturing images of sufficient quality to discern ink drops of about 2 um to about 100 um in diameter. Accordingly, the imaging system 124 may include a telescope zoom lens and may have high resolution (e.g., at least about 1024×768 pixels). Other camera types and/or resolutions may also be used. The imaging system 124 may also be equipped with motorized/automated aiming, zooming, and/or focusing features. In operation, the imaging system 124 may be used to inspect nozzles of the print heads 108, 110, 112 to determine if the nozzles may benefit from a cleaning and/or an inkphobic surface treatment (e.g., because ink appears to have built-up or dried on the nozzles, clean solvent flowed through the nozzles is not clear or has ink color, and/or ink appears to no longer bead on the surface of the nozzles/print heads).

The print bridge 102, stage 104, and/or inkjet print heads 108, 110, 112 may be coupled to system controller 114. System controller 114 may be adapted to control motion of the print bridge 102, the stage 104, and/or the inkjet print heads 108, 110, 112 in inkjet printing operations. System controller 114 may also control firing pulse signals for inkjet print heads 108, 110, 112. In at least one embodiment, the system controller 114 may comprise a single controller or multiple controllers.

The print head parking stations 116, 118, 120 may be disposed below the level of the stage 104 and be adapted to each individually be raised up independently to receive a print head 108, 110, 112. In some embodiments, the system 100 may include one print head parking station 116, 118, 120 per print head 108, 110, 112. In additional or alternative embodiments, one parking station 116 may be used with multiple print heads 108, 110, 112 or multiple parking stations 116, 118, 120 may be used with a single print head 108. For example, a first parking station 116 may be adapted to rinse a print head 108 in solvent, a second parking station 118 may be adapted to dry the print head 108 with compressed air, and a third parking station may be adapted to coat the print head with an inkphobic surface treatment. Likewise, a single parking station 116 may be adapted to perform all three of the above example functions in addition to other maintenance, cleaning, and/or protection functions on one or more print heads 108, 110, 112. Thus, in various embodiments, any number of print heads 108, 110, 112 may be serviced or maintained by performing any number of functions on the print heads 108, 110, 112 by any number of parking stations 116, 118, 120.

One or more print head clean stations 122 may also be disposed in the same or similar manner and locations as the print head parking stations 116, 118, 120. Previously incorporated U.S. patent application Ser. No. 11/238,631 describes in detail many features and aspects of an example of a print head cleaning station suitable for use with the present inkjet printing system 100.

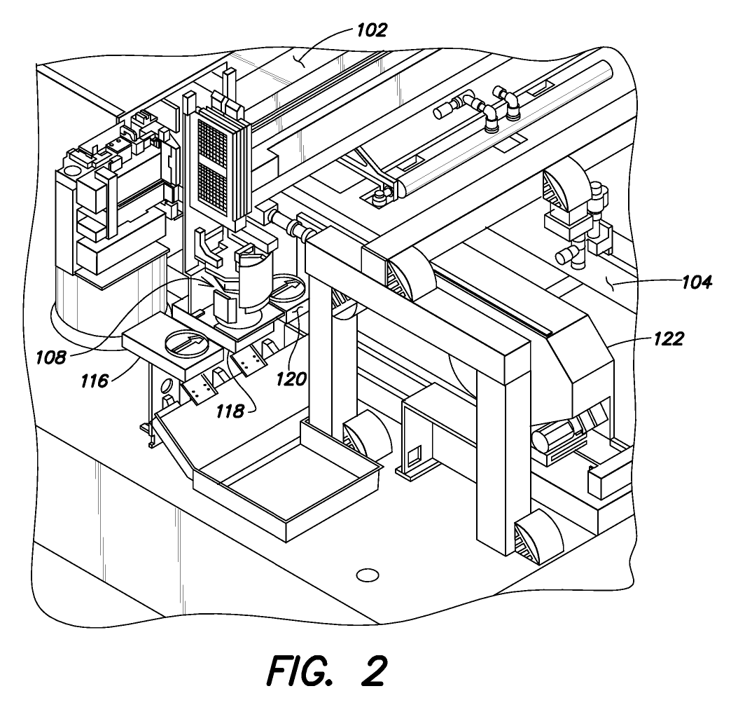

Turning to FIG. 2, a close-up perspective view of a print head 108 located above a center one of three example embodiments of print head parking structures 116, 118, 120 is depicted. In contrast to FIG. 1, the print head 108 is shown parked within one of the parking structures 118. Note that in some embodiments, the print head parking structures 116, 118, 120 may be disposed adjacent one side of the stage 104. Alternatively or additionally, parking structures may be disposed at both sides, the front, and/or rear of the stage. Such embodiments are adapted to facilitate use of the parking structures while minimizing the time and/or distance over which the print heads would have to be moved to reach the parking structures.

The print head parking structures 116, 118, 120 may be adapted to rise up to engage the print heads 108, 110, 112 at or above the level of the stage 104. In addition, the parking structures 116, 118, 120 may be adapted to be lowered to, or below, the level of the stage 104 to provide clearance to move the print heads 108, 110, 112 laterally over the recessed parking structures 116, 118, 120. In some embodiments, the parking structures 116, 118, 120 may have a fixed vertical position and the print heads 108, 110, 112 may be adapted be lowered and raised to engage and disengage the parking structures 116, 118, 120.

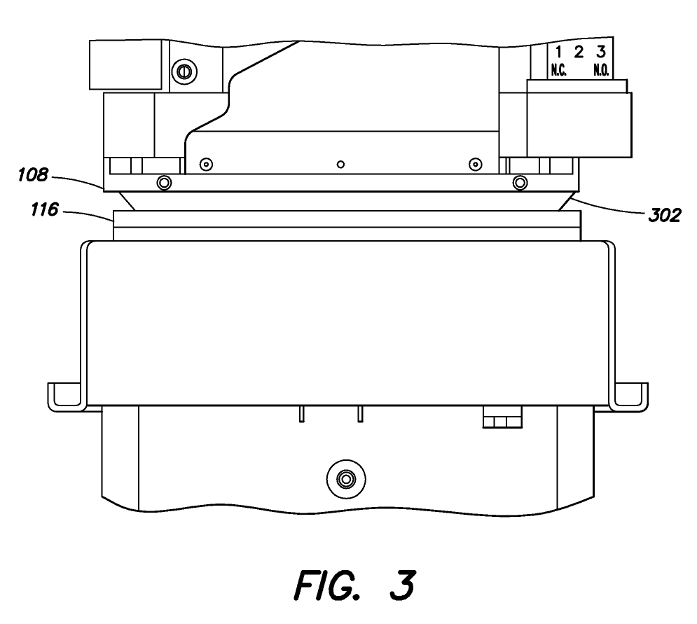

Turning to FIG. 3, a front plan view of a print head 108 parked in an example parking structure 116 is depicted. The parking structure 116 includes a seal 302 that is adapted to receive the nozzle portion of the print head 108. The seal 302 contacts a flat portion of the surface of the print head 108 such that solvent within the parking structure 116 is contained and is prevented from splashing out of the parking structure 116 while the print head 108 is parked (e.g., during a purge process or an ultrasonic rinsing process). The seal 302 may be embodied as a flexible bellows adapted to be compressed and to conform to the surface of the print head 108 when either the parking structure 116 is raised to engage the print head 108 or the print head 108 is lowered into the parking structure 116. The seal 302 may be made from any number of materials including rubber, plastics, thin sheet metal, flexible or semi-rigid polyvinylchloride (PVC), or any practicable material that is compressible to form a seal and not reactive with inks, solvents, print head surface treatments, and/or any other chemical or process that may be used with the parking structure 116.

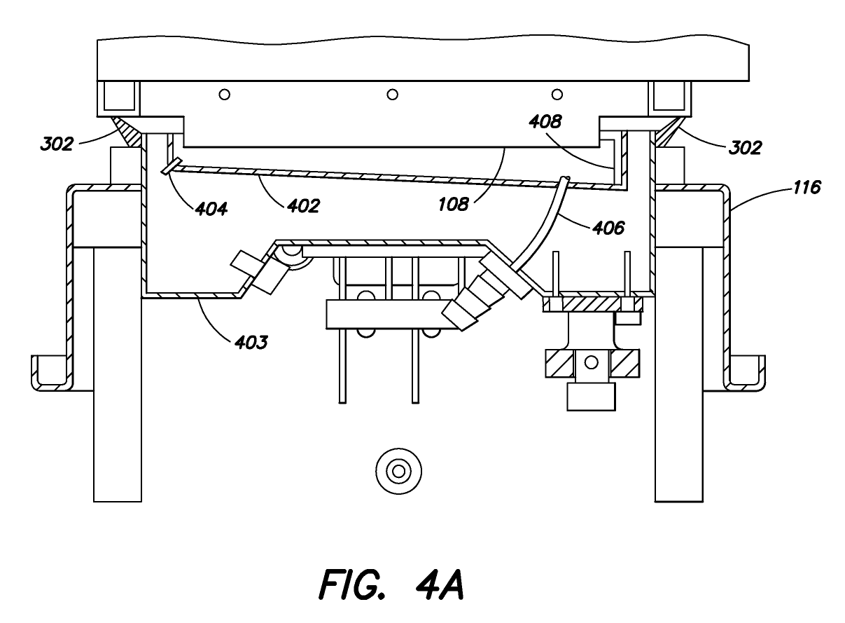

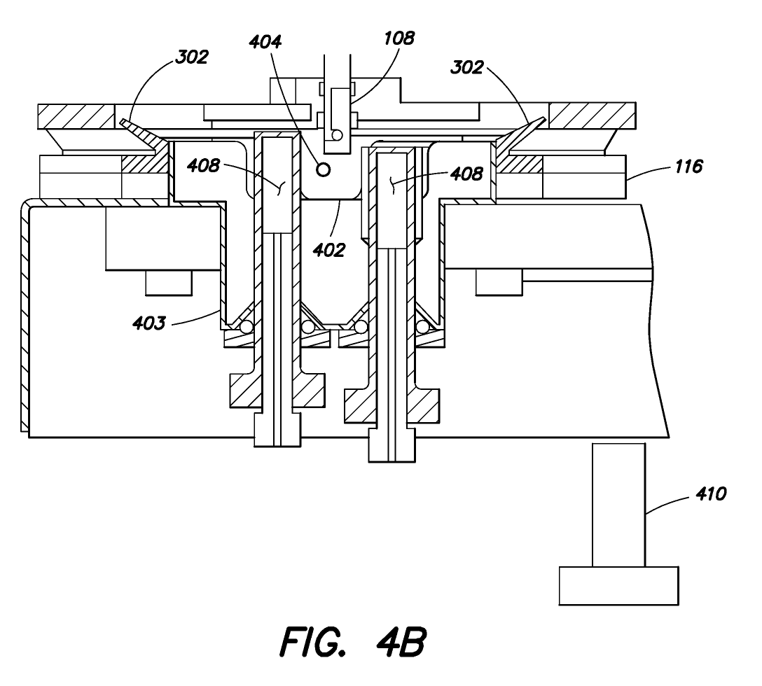

Turning to FIGS. 4A and 4B, cross-sectional front and side plan views of a print head 108 parked in an example parking structure 116 are depicted. The example parking structure 116 depicted in FIGS. 4A and 4B includes a pool 402 that is recessed into an enclosure 403. The pool 402 includes a supply line 404 and a drain line 406 (both including attendant control valves) for filling and emptying the pool 402, respectively, with solvent and/or surface treatment chemicals. The pool 402 may also include one or more fluid level sensors 408. As indicated above, the parking structure 116 may be adapted to move vertically to engage and disengage a print head 108. In some embodiments, an actuator 410 (e.g., a pneumatic or hydraulic cylinder either alone or in conjunction with a cam or up/down rotation shaft) may be employed to raise and lower the parking structure 116.

The pool 402 and the enclosure 403 may be formed from a single piece of material or from two or more pieces. In some embodiments, the pool 402 may be embodied as, or include, a liner that may be easily removed for cleaning or other purposes. The pool 402 and the enclosure 403 may be made from any number of various metals (e.g., aluminum, stainless steal, etc.), plastics, and/or other materials that are practicable. Other shapes than those depicted in the figures may be employed. In some embodiments, the pool 402 may be shaped to facilitate drainage of used fluids. In some embodiments, the pool 402 may be shaped, for example, to facilitate a particular flow pattern of solvent to enhance the rinsing effect of the solvent.

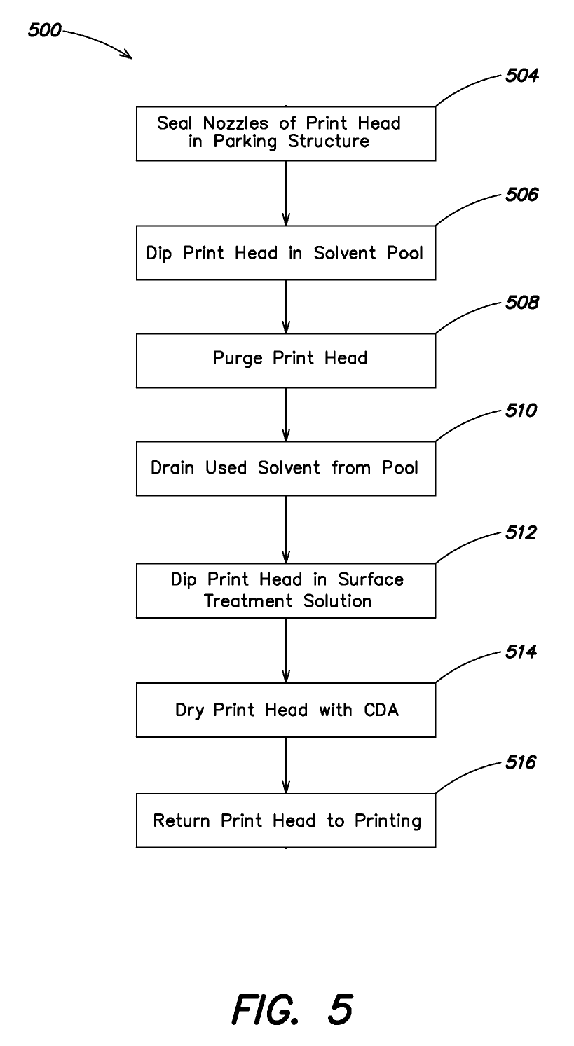

Turning to FIG. 5, a method 500 of processing a print head 108 in a parking structure 116 is depicted. In Step 504, the print head 108 is sealed in the parking structure 116. In operation, the system controller 114 may direct the system 100 to being the print head 108 to a park position above the parking structure 116 after completing, before starting, and/or during printing operations. The park position may be a known position that the inkjet printing system 100 stores in the memory of the system controller 114. In some embodiments, the park position may be determined or verified through the use of sensors or other devices disposed on the parking structures 116 and/or the print heads 108. Once the print head 108 is in the park position, the actuator 410 may be directed by the system controller 114 to raise the parking structure 116 so that the seal 302 engages a surface of the print head 108 and the lower end of the print head 108 (including the nozzles of the print head 108) are disposed within the pool 402.

In some embodiments, the actuator 410 may be adapted to allow the parking structure 116 to be held at two different positions while the seal 302 is engaged. In a first position, the seal 302 is engaged but the print head 108 is above the pool 402. In a second position, the seal 302 is engaged and the print head 108 is submerged in the pool 402. The first position may be useful for spraying the print head 108 (e.g., with solvent or surface treatment, or with CDA, for example, to dry the print head 108) or for inspecting/testing the print head 108 while the print head is in the parking structure 116 (e.g., the output of the print head 108 maybe examined while solvent is jetted into the pool 402). The second position may be useful for dipping the print head 108 in solvent and/or surface treatment. In either position, the seal 302 maintains contact with the print head 108 so that ink, solvent, surface treatment solution, etc. remain contained in the parking structure 116.

Once the print head is sealed in the parking structure 116, the print head 108 may then be sprayed or dipped in solvent in Step 506. In Step 508, any remaining ink within the print head 108 may be purged into the pool 402 by firing each of the nozzles of the print head 108 with the ink supply turned off. In some embodiments, the print head 108 may then be purged with solvent by jetting a solvent only solution through each of the nozzles of the print head 108. Generally, to purge ink from the print head 108, the inkjet print head 108 may force any remaining ink inside the print head 108 out of the print head 108 via any suitable method. As indicated above, this may include, for example, jetting ink and/or air through the print head 108. In one or more embodiments, ink and/or air may be jetted through the print head 108 using a pulse having a duration of about 0.5 seconds, although any other practicable pulse widths may be used. In an exemplary embodiment, print head 108 may purge between approximately three and six cubic centimeters of ink per cycle. The print head 108 may be purged onto a cleaning medium of a cleaning station 122 and/or into the parking structure 116 as described above.

In some embodiments, the ink and solvent solution collected in the pool 402 may then be drained from the pool 402 via the drain line 406 so that the pool 402 may be filled with clean solvent via the supply line 404. In other embodiments, the solvent may be re-used. The fluid level sensors 408 may be used to determine that a desired level of solvent has been supplied to the pool 402 to insure, for example, that the print head nozzles have been completely submerged. In some embodiments, vibration (e.g., 20 KHz) and/or heat energy may be imparted to the solvent solution to help dissolve any ink on the print head 108. Thus, in such embodiments, the pool 402 may include, for example, one or more megasonic transducers/vibrators and/or heaters. Additionally, the pool 402 may include one or more nozzles adapted to inject or spray additional solvent and/or air into the pool 402 to further aid in dissolving any ink on the print head 108. The pool 402 may include a vent to allow air to exhaust as well as a valve coupled to the drain line 406 that is adapted to maintain the solvent solution level based on feedback from the fluid level sensors 408, particularly as additional solvent is added to the pool 402.

After the lower end of the print head 108 (including the nozzles of the print head 108) have been appropriately rinsed in the pool 402 for a suitable period of time, the pool 402 may be drained of used solvent and dissolved ink via the drain line 406 in Step 510. In some embodiments the print head 108 may merely be dipped in the solvent for a very short period. In other embodiments, the print head 108 may remain in solvent in the pool 402 for an extended period (e.g., minutes, hours, etc.). In some embodiments, before the pool 402 is drained, the parking structure 116 may be lowered by the actuator 410 (e.g., to the first position described above) to allow an operator and/or the system 100 to examine (e.g., using an imaging system) and/or test the print head 108 to assess whether any ink remains on the print head 108. If ink remains, the print head 108 may be returned to the parking structure 116 for additional rinsing and possibly for additional cycles of purging, rinsing, inspecting, etc.

After the solvent has been drained in Step 510, and while the print head 108 remains in (or has been returned to) the parking structure 116, the print head 108 may be sprayed with CDA to dry the print head 108. Once the print head 108 is dry, the parking station 116 may be lowered to disengage the seal 302 and the print head 108 may be ready to start, or return to, printing operations.

In some embodiments, before or after the print head 108 has been dried, in Step 512, the pool 402 may be filled with an inkphobic surface treatment solution and the print head 108 may be dipped in the solution. The print head 108 may not be dried before Step 512 in alternative embodiments. The solution may alternatively or additionally be sprayed onto the print head 108. As with the solvent, the fluid level sensors 408 may be used to determine an appropriate amount of inkphobic surface treatment solution to add to the pool 402. In some embodiments, heat may be applied to the solution as part of the process of treating the print head 108. As with the solvent, in some embodiments the print head 108 may merely be dipped in the inkphobic surface treatment solution for a very short period. In other embodiments, the print head 108 may remain in the inkphobic surface treatment solution in the pool 402 for an extended period (e.g., minutes, hours, etc.). After appropriate exposure to the surface treatment process, the print head 108 may be dried (e.g., using CDA) in Step 514, the parking structure may be lowered to disengage the seal 302, and the print head 108 may be ready to start, or continue, printing operations in Step 516.

Aspects of the present invention include coating or treating the nozzle surfaces of the print head 108 with hydrophobic or inkphobic materials. The coatings improve jetting reliability and drop size repeatability. Many different types of coatings may be used depending on the types of inks employed and other factors. For example, a mixture of alkyl thiol and ionic alkyl thiol may be dissolved in a solvent to create the solution for a surface treatment. In some embodiments, for example, the ratio of alkyl thiol, ionic alkyl thiol in the solvent may be in the range of approximately 0.5˜5 mM: 0.3˜5 mM. In some embodiments, the surface treatment solution may be made from any material whose molecules include either a sulfur atom or a nitrogen atom on the “active” end (e.g., the end of the molecule that bonds to the nozzle surfaces) and a carbon fluorine (e.g., CFx where x is any number) group of atoms on the other, inkphobic end of the molecule. Examples include: CF3(CF2)xCF2C2H4SH, such as 1H,1H,2H,2H-Perfluoro-1-decanethiol 3,3,4,4,5,5,6,6,7,7,8,8,9,9,10,10,10-Heptadecafluoro-1-decanethiol and 1H,1H,2H,2H-Perfluoro-1-hexanethiol 3,3,4,4,5,5,6,6,6-Nonafluoro-1-hexyl mercaptane.

In operation, the print heads 108 may be dipped in the surface treatment solution at regular intervals (e.g., after one or more print passes, after print head cleaning/wiping, after a period of non-use, etc.). In some embodiments, the surface treatment solution may be employed to enhance other deposition processes in addition to printing color filters for flat panel displays.

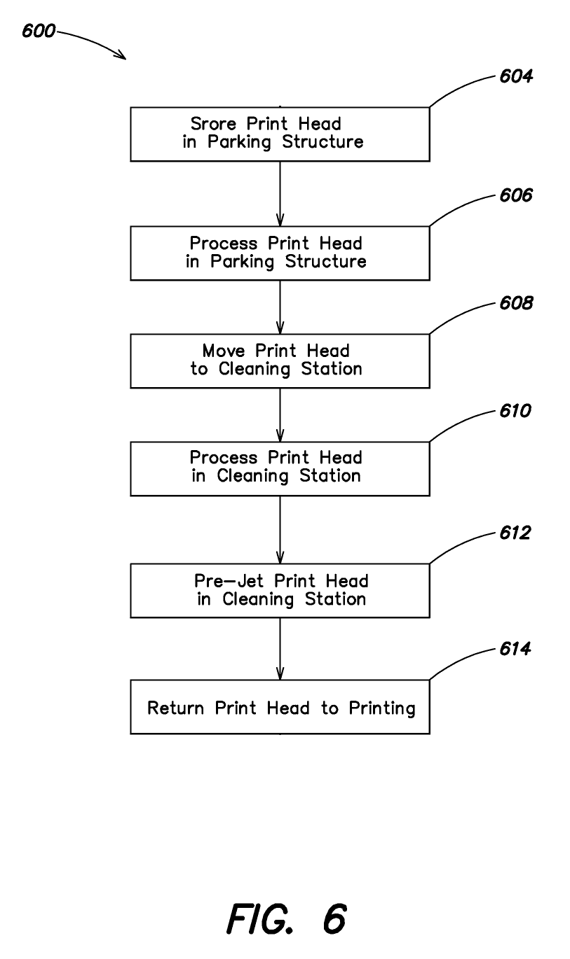

Turning to FIG. 6, a method 600 of printing operations is depicted. In some embodiments, print heads 108, 110, 112 may remain sealed in respective parking structures 116, 118, 120 while a substrate 106 is loaded or removed from the stage. Thus, in Step 604, the print heads 108, 110, 112 are stored in the respective parking structures 116, 118, 120.

In Step 606, the print heads 108, 110, 112 may be processed in the respective parking structures 116, 118, 120 according to the methods described above and with respect to FIG. 5. For example, the print heads 108, 110, 112 may be submerged in solvent within the parking structures 116, 118, 120. Further, the print heads 108, 110, 112 may be purged within the parking structures 116, 118, 120 and/or inspected. In some embodiments, the print heads 108, 110, 112 may receive a nozzle surface treatment in the respective parking structures 116, 118, 120 and/or be dried with CDA.

In some embodiments, in Step 608, one or more of the print heads 108, 110, 112 may next be moved to the cleaning station 122 where the print heads 108, 110, 112 may be further processed. For example, the print heads 108, 110, 112 may be wiped or otherwise conditioned as described in previously incorporated U.S. patent application Ser. No. 11/238,631. In Step 612, the heads 108, 110, 112 may also be pre-jetted at the cleaning station 122 to stabilize the ink pressure within the system 100.

In Step 614, the print heads 108, 110, 112 may be returned to a printing location so that printing may commence or continue. In alternative embodiments, the wiping at the cleaning station 122 may be performed before the surface treatment is applied to the nozzles at the parking structures 116, 118, 120. Between processing subsequent substrates, the print heads 108, 110, 112 may be returned to the respective parking structures 116, 118, 120. In alternative embodiments, various different sequences of using the parking structures 116, 118, 120 and the cleaning station 122 may be employed. For example, the print heads 108, 110, 112 may be returned to the respective parking structures 116, 118, 120 for a solvent or surface treatment dip after each printing pass.

FIG. 7 is a schematic perspective view of an exemplary inkjet printing system 701 including movable maintenance modules in accordance with an embodiment of the present invention. With reference to FIG. 7, the system 701 may include a stage 703 (shown in phantom) movably coupled to a frame 705. More specifically, the frame 705 may include and/or be coupled to one or more rails 707, and the stage 703 may include and/or be coupled to one or more features (e.g., rollers) 709 adapted to movably couple to the rails 707 such that the stage 703 may be adapted to move in a direction (e.g., in a y-axis direction) along the rails 707. The stage 703 may be adapted to support a substrate 711, such as a flat panel display or the like, thereon. The substrate 711 may include one or more display objects 713 formed thereon.

The system 701 may include a bridge 715 coupled to and/or included in the frame 705 such that as the stage 703 (and substrate 711 supported thereon) moves along the rails 707, the stage 703 and substrate 711 may pass below the bridge 715. One or more inkjet print heads 717 may be coupled to the bridge 715 and adapted to dispense ink onto a display object 713 of the substrate 711 as the substrate 711 passes thereunder. Each inkjet print head 717 may include and/or be coupled to a corresponding inkjet print head position and orientation control mechanism 719 adapted to adjust printhead position and/or orientation. Alternatively, the one or more inkjet print heads 717 may be coupled to a single inkjet print head position and orientation control mechanism 719.

In some embodiments, the inkjet print heads 717 may be cleaned and/or calibrated before inkjet printing (e.g., before dispensing ink onto substrate display objects 713). However, after or during inkjet printing one or more substrates 711, at least one inkjet print head 717 may require maintenance. For example, one or more nozzles of at least one inkjet print head 717 may become clogged or otherwise obstructed by ink drying on or in the inkjet print head 717. Therefore, such inkjet print head 717 may require cleaning. Additionally or alternatively, after or during inkjet printing one or more substrates 711, a calibration of at least one inkjet print head 717 may be adversely affected. Therefore, the position and orientation control mechanism 719 corresponding to the inkjet print head 717 may require calibration. Additionally or alternatively, the consistency and/or precision with which droplets of the ink are dispensed from the at least one inkjet print head 717 may need to be verified and possibly adjusted.

Therefore, the system 701 may include a plurality of maintenance modules 721. For example, the system 701 may include at least one inkjet print head parking station (only one shown) 723. An inkjet print head parking station 723, as discussed above. Additionally or alternatively, the system 701 may include at least one cleaning station 725. A cleaning station 725 may be adapted to position and move a cleaning medium adjacent the inkjet print head 717 such that ink may be removed from the inkjet print head 717. Details of the cleaning station are described in previously incorporated U.S. patent application Ser. No. 11/238,631.

Additionally or alternatively, the system 701 may include at least one inkjet print head calibration system 727 (e.g., an upward viewing calibration imaging system) adapted to calibrate the position and orientation control mechanism 719 of the inkjet print head 717. Details of the inkjet print head calibration system 727 are described in previously incorporated U.S. patent application Ser. No. 11/019,930.

Additionally or alternatively, the system 701 may include at least one inkjet droplet visualization system 729. An inkjet droplet visualization system 729 may be adapted to adjust at least one of the consistency and precision with which droplets of the ink are dispensed from the inkjet print head 717. Details of the inkjet drop visualization system 729 are described in previously incorporated U.S. patent application Ser. No. 11/123,502.

The maintenance modules 721 described above are exemplary. Therefore, the system 701 may include a larger or smaller number of and/or different types of maintenance modules 721. Further, the system 701 may include one or more cameras 730 (only one shown) or similar monitoring means adapted to determine whether an inkjet print head 717 requires cleaning, calibration and/or other maintenance. In some embodiments, the one or more cameras 730 may be positioned on the print bridge 715. However, the cameras 730 may be positioned elsewhere. Further, in some embodiments, cameras included in the inkjet print head parking station 723, inkjet print head calibration system 727 and/or inkjet droplet visualization system 729 may serve as the one or more cameras 730.

A maintenance module included in some existing systems for manufacturing display devices may be immobile. For example, the maintenance module may be in a stationary position along an end of the print bridge or the perimeter of the stage. However, in the present system 701, the one or more maintenance modules 721 may move. For example, the system 701 may include one or more platforms 731 movably coupled to the frame 705. The platform 731 may be similar to the stage 711. More specifically, the platform 731 may include and/or be coupled to one or more features (e.g., rollers) 733 adapted to movably couple to the rails 707 such that the platform 731 may be adapted to move in a direction (e.g., in a y-axis direction) along the rails 707. Such direction may be approximately the same as the direction in which the substrate 711 is moved by the stage 703 during display device manufacturing. In some embodiments, the system 701 may include a track 735 on which the features 733 move. However, the platform 731 may be movably coupled to the frame 705 in a different manner. In some embodiments, the platform 731 may be movably coupled to a different component of the system 701. In some other embodiments, the platform 731 may not be coupled to a component of the system 701. For example, the platform 731 may be a free standing support that moves relative the inkjet print heads 717. Although the platform 731 and stage 703 are shown as separate components, in some embodiments, the platform 731 may be integrated with the stage 703 (e.g., may be a portion of the stage 703).

The platform 731 may be adapted to couple to the one or more maintenance modules 721, such as the at least one inkjet print head parking station 723, at least one cleaning station 725, at least one inkjet print head calibration system 727, at least one inkjet droplet visualization system 729, etc. For example, the platform 731 may support the one or more maintenance stations thereon. The one or more maintenance modules 721 may be coupled (e.g., fixedly) to the platform 731 using nuts and bolts, screws or any other suitable coupling means. The platform 731 may be formed from any suitable material. In some embodiments, the platform 731 may be adapted to move in one or more of the x-axis, y-axis and z-axis directions. Additionally or alternatively, the platform 731 may be adapted to rotate. In this manner, the system 701 includes movable (e.g., in a direction approximately the same as the direction in which the substrate 711 is moved during display device manufacturing) maintenance modules 721 for an inkjet printing system. However, in some embodiments, the platform 731 (and maintenance stations 721 coupled thereto) may move in a direction different from the direction in which the stage moves. For example, in some embodiments, the platform 731 and maintenance modules 721 coupled thereto may be positioned under the bridge at a level below that of the stage 703 such that the platform 731 and maintenance modules 721 do not obstruct the stage 703 (and substrate supported thereon 711) during display device manufacturing. In such embodiments, the platform 731 may be adapted to move in the z-axis direction to position the modules 721 for maintenance.

A controller 737 may be coupled to the platform 731 and control movement thereof. The controller 737 may receive signals from the one or more cameras 730 indicating whether one or more inkjet print heads 717 require cleaning and/or calibration, and control movement of the platform 731 based thereon such that an appropriate maintenance module 721 may be moved or brought to an inkjet print head 717 requiring such maintenance. In this manner, the one or more maintenance modules 721 may be moved to any inkjet print head 717 requiring maintenance when such inkjet print head 717 is in a printing position (e.g., in a position normally employed to deposit ink onto display objects 713 of the substrate 711). Thus, the system 701 may not require an inkjet print head 717 to move to an edge 739, 741 of the print bridge 715 or a perimeter 743 of the stage 703 for maintenance. A time required for such movement would increase processing time required to manufacture display devices. However, because the inkjet print heads 717 may remain positioned to deposit ink onto display objects 713 of the substrate 711 during maintenance, the system 701 may avoid such a time required to move the inkjet print head 717 to an end 739, 741 of the print bridge 715 or a perimeter 743 of the stage 703, during which the inkjet print head 717 may not be employed to manufacture display devices.

The controller 737 may be any suitable computer or computer system, including, but not limited to, a mainframe computer, a minicomputer, a network computer, a personal computer, and/or any suitable processing device, component, or system. Likewise, the controller 737 may comprise a dedicated hardware circuit or any suitable contribution of hardware and software. System components such as the platform 731, one or more maintenance modules 721, features 733, track 735, controller 737, inter alia, may serve as an apparatus for inkjet printing system maintenance.

Thus, in the system 701, maintenance modules 721 may be mounted on a movable platform 731 that may travel in the print direction (e.g., in the y-axis direction) toward the inkjet print heads 717 to allow maintenance to be performed on the print heads 717. For example, the movable maintenance modules 721 may be positioned under the bridge 715 to allow the print heads 717 to be cleaned and/or calibrated. The movable maintenance modules 721 may improve processing performance by allowing the print heads 717 to remain in a printing position during maintenance (as opposed to other systems in which print heads having to move (e.g., in an x-axis direction) to various fixed-location maintenance modules around the perimeter of a stage).

The foregoing description discloses only exemplary embodiments of the invention; modifications of the above disclosed methods and apparatus which fall within the scope of the invention will be readily apparent to those of ordinary skill in the art. For instance, although the above example methods are generally described with reference to only one parking structure per print head as described above with reference to FIG. 1, one of ordinary skill in the art would understand that these methods may be applied with any suitable number of parking structures (e.g., 2, 3, 4, etc.) disposed in any practicable location.

In some embodiments, the inkjet print head parking stations of the present invention may be mounted on and/or used with an inkjet printing system such as disclosed in previously incorporated U.S. Provisional Patent Application Ser. No. 60/625,550. Further, the present invention may also be applied to processes for spacer formation, polarizer coating, and nanoparticle circuit forming.

Accordingly, while the present invention has been disclosed in connection with specific embodiments thereof, it should be understood that other embodiments may fall within the spirit and scope of the invention, as defined by the following claims.

What is claimed is:

1. A method of operating an inkjet printing system for manufacturing color filters for flat panel displays, comprising:
processing a print head in a parking structure;
processing the print head in a cleaning station;
pre-jetting the print head in the cleaning station; and
printing a color filter.

2. The method of claim 1 wherein processing the print head in the parking structure includes:
sealing nozzles of the print head in the parking structure; and
dipping the nozzles in a solvent in a pool.

3. The method of claim 2 wherein processing the print head in the parking structure further includes:
spraying the print heads with solvent emitted by spray nozzles positioned in the pool of solvent.

4. The method of claim 2 wherein processing the print head in the parking structure further includes:
purging the print head into the pool.

5. The method of claim 2 wherein processing the print head in the parking structure further includes:
draining used solvent from the solvent pool.

6. The method of claim 5 wherein processing the print head in the parking structure further includes:
refilling the solvent pool with new solvent.

7. The method of claim 5 wherein processing the print head in the parking structure further includes:
filling the solvent pool with a surface treatment solution.

8. The method of claim 7 wherein processing the print head in the parking structure further includes:
dipping the nozzles in the surface treatment solution.

9. The method of claim 8 wherein the surface treatment solution includes a mixture of alkyl thiol and ionic alkyl thiol dissolved in a solvent.

10. The method of claim 2 wherein processing the print head in the parking structure further includes:
drying the print head.

11. The method of claim 10 wherein the drying the print head is achieved through the use of clean dry air.

12. The method of claim 1 wherein processing the print head in the cleaning station further includes:
wiping the print head with a cleaning medium.

13. The method of claim 1 wherein the parking station is coupled to a moving platform adapted to position the parking station directly under the print head.

14. A system for inkjet printing color filters for flat panel displays comprising:
a print head mounted on a bridge and adapted to be moved between a printing location, a parking location, and a cleaning location;
a parking structure disposed at the parking location; and
a cleaning station disposed at the cleaning location.

15. The system of claim 14 wherein the system is operative to:
process the print head in the parking structure;
process the print head in the cleaning station;
pre-jet the print head in the cleaning station; and
print a color filter.

16. The system of claim 14 wherein the parking structure further includes a solvent pool in which nozzles of the print head are dipped.

17. The system of claim 14 wherein the parking structure further includes a solvent pool including at least one spray nozzle for spraying the print head with solvent.

18. The system of claim 14 wherein the parking structure further includes a pool of surface treatment solution in which nozzles of the print head are dipped.

19. The system of claim 18, wherein the surface treatment solution includes hydrophobic materials.

20. The system of claim 18, wherein the surface treatment solution includes inkphobic materials.

21. The system of claim 18 wherein the surface treatment solution includes a mixture of alkyl thiol and ionic alkyl thiol dissolved in a solvent.

22. The system of claim 14, wherein the parking station further includes clean dry air for drying the print head.

23. The system of claim 14, wherein the cleaning station further includes a cleaning medium adapted to wipe the print head.
